(19) United States
(12) Patent Application Publication
(10) Pub. No.: US 2013/0332380 A1
(43) Pub. Date: Dec. 12, 2013

(54) DETERMINATION OF A CONTRACTOR TEAM

(71) Applicant: Ezekiel Kruglick, Poway, CA (US)

(72) Inventor: Ezekiel Kruglick, Poway, CA (US)

(73) Assignee: Empire Technology Development LLC, Wilmington, DE (US)

(21) Appl. No.: 13/701,377

(22) PCT Filed: Jun. 11, 2012
(86) PCT No.: PCT/US12/41877

§ 371 Date: Nov. 30, 2012

(51) Int. Cl. G06Q 10/10

(52) U.S. Cl. CPC G06Q 10/1053
USPC 705/321

(57) ABSTRACT

Technologies are generally described for systems, methods and devices configured to determine a contractor team from a group of contractors. An example method may include receiving hiring details, receiving profiles of contractors in the group, receiving social data and determining the contractor team based on the hiring details, the profiles, and the social data. The hiring details may include technical details and social details. The technical details may indicate requested first skills of contractors in the contractor team. The social details may indicate a request of a first strength of a social connection between two or more of the contractors in the contractor team. The profiles may indicate second skills of respective contractors. The social data may relate to a second strength of a social connection between at least two of the contractors in the group.

### BACKGROUND

Unless otherwise indicated herein, the materials described in this section are not prior art to the claims in this application and are not admitted to be prior art by inclusion in this section.

A network such as the Internet is a collection of computers and/or processors connected to be in communication. Some processors in communication with the Internet provide a contractor marketplace service. A user may provide a set of skills to the contractor marketplace service and receive profiles of candidates who match the skills in response.

### SUMMARY

In an example, methods for determining a contractor team from a group of contractors are generally described. The methods may include, by a processor, receiving hiring details. The hiring details may include technical details and social details. The technical details may indicate requested first skills of contractors in the contractor team. The social details may indicate a request of a first strength of a social connection between two or more of the contractors in the contractor team. The methods may further include receiving profiles of contractors in the group. The profiles may indicate second skills of respective contractors. The methods may further include receiving social data relating to a second strength of a social connection between at least two of the contractors in the group. The methods may further include determining the contractor team based on the hiring details, the profiles, and the social data.

In an example, devices configured to determine a contractor team from a group of contractors are generally described. The devices may include a memory including instructions and a processor configured to communicate with the memory. The processor may be configured to receive hiring details. The hiring details may include technical details and social details. The technical details may indicate requested first skills of contractors in the contractor team. The social details may indicate a request of a first strength of a social connection between two or more of the contractors in the contractor team. The processor may further be configured to receive profiles of contractors in the group. The profiles may indicate second skills of respective contractors. The processor may be configured to receive social data relating to a second strength of a social connection between at least two of the contractors in the group. The processor may further be configured to determine the contractor team based on the hiring details, the profiles, and the social data.

In an example, systems configured to determine a contractor team from a group of contractors are generally described. The systems may include a contractor marketplace site, a social network, and a contractor processor configured to be in communication with the contractor marketplace site and the social network. The contractor processor may be configured to receive hiring details. The hiring details may include technical details and social details. The technical details may indicate requested first skills of contractors in the contractor team. The social details may indicate a request of a first strength of a social connection between two or more of the contractors in the contractor team. The contractor processor may be configured to receive profiles of contractors in the group from the contractor marketplace site. The profiles may indicate second skills of respective contractors. The contractor processor may be configured to receive a social connection graph from the social network. The social connection graph may relate to a second strength of a social connection between at least two of the contractors in the group. The contractor processor may be configured to determine the contractor team based on the hiring details, the profiles, and the social data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates some example systems that can be utilized to implement determination of a contractor team;

FIG. 2 illustrates some example systems that can be utilized to implement determination of a contractor team;

FIG. 3 illustrates some example systems that can be utilized to implement determination of a contractor team;

FIG. 4 depicts a flow diagram for example processes for implementing determination of a contractor team;

FIG. 5 illustrates computer program products for implementing determination of a contractor team; and

FIG. 6 is a block diagram illustrating an example computing device that is arranged to implement determination of a contractor team;

all arranged according to at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to determination of a contractor team.

Briefly stated, technologies are generally described for systems, methods and devices configured to determine a contractor team from a group of contractors. An example method may include receiving hiring details, receiving profiles of contractors in the group, receiving social data, and determining the contractor team based on the hiring details, the profiles, and the social data. The hiring details may include technical details and social details. The technical details may indicate requested first skills of contractors in the contractor team. The social details may indicate a request of a first strength of a social connection between two or more of the contractors in the contractor team. The profiles may indicate second skills of respective contractors. The social data may relate to a second strength of a social connection between at least two of the contractors in the group.

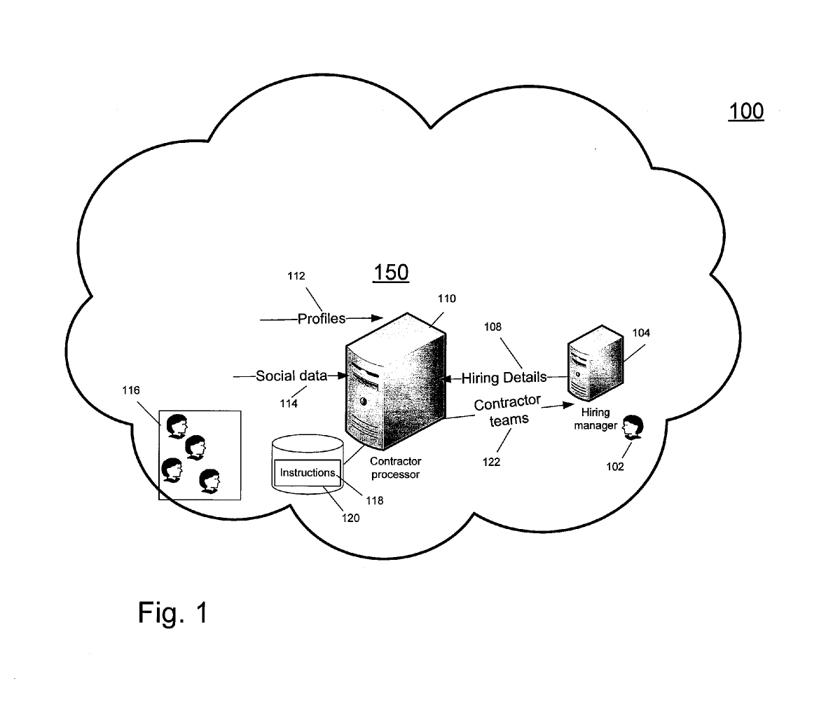

FIG. 1 illustrates some example systems that can be utilized to implement determination of a contractor team. In some examples, as explained in more detail below, a system 100 may include a hiring manager processor 104, and/or a contractor processor 110 configured to be in communication through a network 150 such as the Internet. Contractor processor 110 may be configured to be in communication with a memory 120 including instructions 118. Contractor processor 110 may receive hiring details 108 from hiring manager processor 104. Hiring details 108 may indicate desired skills requested and a strength of a social connection desired or necessary between two or more contractors in a group 116 of contractors. Contractor processor 110 may also receive profiles 112 and social data 114 relating to group 116 of contractors. Based on hiring details 108, profiles 112 and social data 114, contractor processor 110 may determine and send contractor teams 122 to hiring manager processor 104.

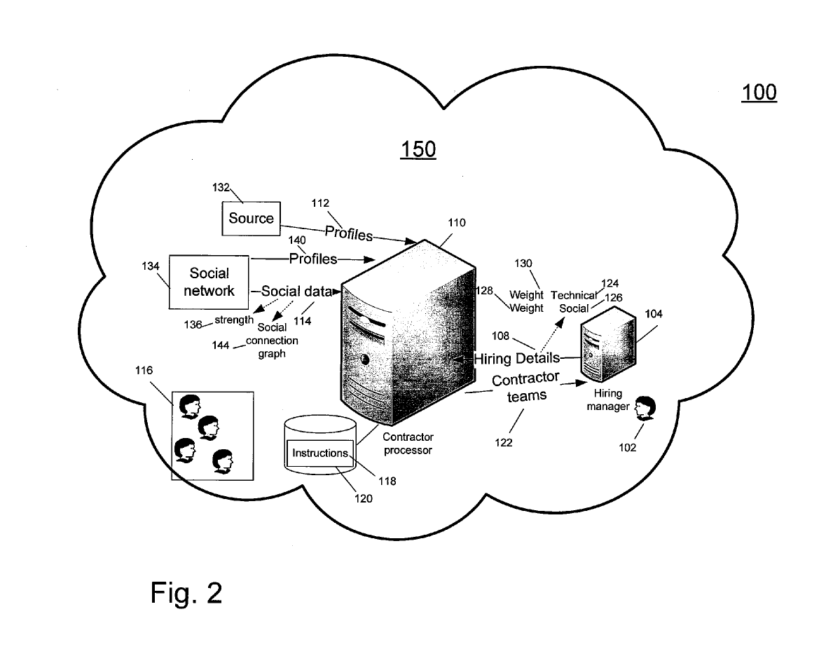

FIG. 2 illustrates some example systems that can be utilized to implement determination of a contractor team arranged according to at least some embodiments described herein. Those components in FIG. 2 that are labeled identically to components of FIG. 1 will not be described again for the purposes of clarity.

Hiring details 108 may include technical details 124 and social details 126. Technical details 124 may include skills of contractors in contractor teams 122 that are requested by hiring manager 102. In an example, technical details 124 may indicate that hiring manager 102 is requesting skills corresponding to a mechanical engineer with 10 years of experience and two programmers, each with 5 years of experience. Technical details 124 may indicate types of contractors, skills of contractors, years of experience, proficiency, etc. Social details 126 may indicate a requested strength of a social connection between or among contractors in contractor teams 122. For example, social details 126 may indicate that contractors are requested to be located a certain number of hops apart from each other in a social graph or connected by a threshold strength level in a social graph. Social details 126 may indicate that contractors are requested to have a social or professional connection to members of the hiring manager's company or team. For example, contractors may be requested to be located a certain number of hops apart from the hiring manager's company or team in a social graph. Contractors may be requested to be connected by a threshold strength level to the hiring manager's company in a social graph.

In an example, technical details 124 and social details 126 may be weighed by hiring manager 102. Hiring manager 102 may indicate a technical weight 130 for technical details 124 and a social weight 128 for social details 126. In an example, social and technical weights 128, 30 may be on a scale of 0 to 100. Technical weight 130 may indicate a level of importance of a match between technical details 124 and skills of contractors in contractor teams 122. Social weight 128 may indicate a level of importance of a match between social details 126 and a strength of a social connection between contractors in contractor teams 122. For example, hiring manager 102 may be more interested that skills of contractors in contractor teams 122 match technical details 124 than a strength of a social connection of contractors in contractor teams 122 match a strength in social details 126. Hiring manager 102 may increase technical weight 130 relative to social weight 128. Social weight 128 may indicate a requested strength of a social connection between any two contractors or among all contractors in contractor team 122.

In an example, a hiring manager may request one contractor who has experience as a mechanical engineer and two contractors who have experience as programmers. The hiring manager may increase a social weight 128 of social details 126 reflecting the strength of connection between the two programmers. For example, the two programmers may have to work closely with each other and so the strength of their connection is particularly important. The increased social weight may indicate that the strength of the connection between the two programmers is more important than the strength of a relationship among other members in the team. However a social weight of social details reflecting a strength between each of the programmers and the mechanical engineer may not be as high. This increase in social weight may also indicate that a match of the strength of the connection between those two programmers to social details 126 is more important than a match of technical details 124 to technical skills of the programmers. A technical weight 130 for technical details of each of the programmers and the mechanical engineer may be adjusted based on how closely the hiring manager requests that skills of the contractors should match the technical details.

Contractor processor 110 may receive profiles 112 from a source 132. Source 132 may be, for example, a contractor marketplace site like ODESK, ELANCE, VWORKER, etc. Profiles 112 may identify skills, expertise, proficiency, etc. of contractors in group 116. In an example, profiles 112 may indicate that some contractors have 10 years of experience as a programmer. Profiles 112 may reflect how much the skills of a contractor in group 116 matches technical details 124.

Contractor processor 110 may receive social data 114 in the form of a social connection graph 144 from a social network 134. Social network 134 may be, for example, FACEBOOK, LINKEDIN, etc. Social data 114 may indicate a strength 136 of a social connection between contractors in group 116. For example, social connection graph 144 may indicate a number of hops between two contractors 116 in a social network. Social connection graph 144 may indicate a strength of a connection in social connection graph 144 between two contractors in group 116. Social connection graph 144 may indicate a number of people that two or more contractors in group 116 know in common. The number of people known by two or more contractors may reflect a strong or weak connection between the two contractors.

Contractor processor 110 may receive social connection graph 144 using, for example, an application programming interface (API) related to social network 134. In another example, contractor processor 110 may be owned by social network 134 so that social connection graph 144 may be shared with contractor processor 110. Similarly, social network 134 may own source 132 so that contractor processor 110 may more easily obtain and receive profiles 112 and social connection graph 144.

In an example, social connection graph 144 may be received from FACEBOOK. For example, an API in the form of the Open Graph standard from FACEBOOK may be used (graph.facebook.com/id/connection_type) by contractor processor 110 to access and receive social connection graph 144. The Open Graph API may include a connections request inquiring about likes, relationships etc. between two contractors in group 116. For example, a response to an API call may indicate connections between two contractors 116 such as: friends, news feed, profile feed, likes, movies, music, books, notes, permissions, photo tags, photo albums, video tags, video uploads, events, groups, check-ins, objects with location, etc.

For example, contractors in group 116 may authenticate contractor processor 110 so that contractor processor 110 may receive information regarding social connection graph 144. In an example where social network 134 is FACEBOOK, a manage_pages permission may be provided by contractors to yield an access_token property for pages administered by the contractors. The access_token property may be used by contractor processor 110 to make calls to social network 134, on behalf of the contractors, to obtain social connection graph 144.

In another example, contractors in group 116 may provide contractor processor 110 access to respective social connection graphs 144 such as through a “log-in with LINKEDIN” or “log-in with FACEBOOK” type function. For example, an OAUTH type third party authorization request may be used. Such a request may then later be rescinded by contractors in group 116 or may expire after a defined time duration. Contractors in group 116 may sign into contractor processor 110 using their respective social network identification. Contractor processor 110 may use a corresponding API for the respective social network 134. An example of pseudo code that may satisfy the OAUTH authorization is shown below.

<script type = “text/javascript” src = “platform.linkedin.com/in.js”>
api_key: api_key_goes_here
</script>
<script type = “in/login”>
Hello, <?js=firstname ?> <?js=lastname ?>
</script>
<script type = “text/javascript” src = “platform.linkedin.com/in.js”>
api_key:api_key_goes_here
authorize:true
</script>

For example, contractor processor 110 may use an API for LINKEDIN. A code may be used to generate a “login with LINKEDIN” button that may allow a contractor to provide contractor processor 110 with an OAUTH permission to access the contractor's respective social connection graph 144. After the OAUTH permission has been granted, contractor processor 110 may send an API call to social network 134 and receive social connection graph 144 in response. Similarly, contractor processor 110 may send an API call to social network 134 and receive additional profiles 140 relating to contractors in group 116 in response. An example of pseudo code that may be used for the API call is shown below.

IN.API.Profile (“12345”)
.fields (“first name”, “headline”, “skill”)
.result (function(result) {
alert JSON.stringify (result))
}

The above pseudo code may be used to retrieve a JSON (java script object notation) data structure with a first name, a headline (such as job title at a company) and skills for profile 12345. In examples where social network 134 is LINKEDIN, additional profiles 140 may be received in the form of JSON objects that include unique identifiers, the name of skills, proficiency levels, years of experience, professions, publications, etc.

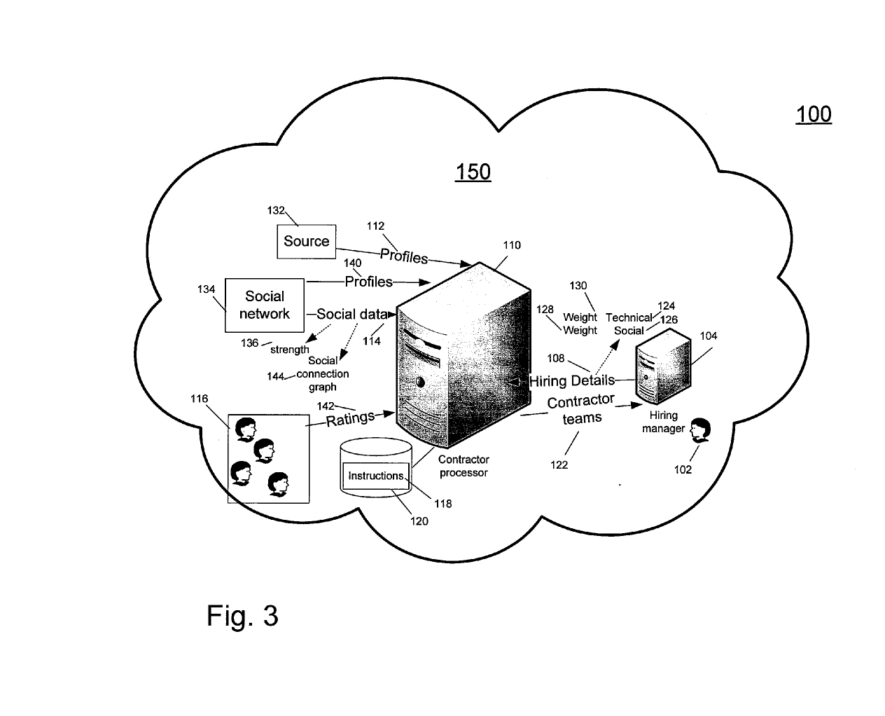

FIG. 3 is illustrates some example systems that can be utilized to implement determination of a contractor team arranged according to at least some embodiments described herein. Those components in FIG. 3 that are labeled identically to components of FIGS. 1 and 2 will not be described again for the purposes of clarity.

Contractor processor 110 may further receive ratings 142 from contractors in group 116. Ratings 142 from a first contractor may indicate a degree of interest in working with a second contractor. Ratings 142 may be secret to other contractors so that a second contractor may not know the rating assigned to him by a first contractor. For example, a first contractor may be good friends with a second contactor but may not like the second contractor's work style. A first contractor may otherwise not want to be paired with a second contactor such as not wanting to break family or friendship ties. A negative rating may be used by contractor processor 110 to reduce a strength of a connection in social connection graph 144. In an example, contractor teams 122 may be sent to hiring manager 102 and not to contractors so that contractors may avoid extrapolating ratings 142 and to preserve a market making role of system 100.

Contractor processor 110 may, in response to instructions 120, process hiring details 108, profiles 112, profiles 140, social data 114 and/or ratings 142 to determine contractor teams 122. Contractor processor 110 may analyze group 116 and generate a score for multiple possible contractor teams based on a degree of match between the member contactors' profile to the technical details and technical weight 130 and the social details and social weight 128. Contractor teams 122 may include a threshold number of contractors. For example, instructions 120 may include linear programming, greedy algorithms, dynamic programming, or other techniques capable of solving complex graph problems. Contractor processor 110 may use MAP-REDUCE and/or HADOOP technologies.

Contractor teams 122 may be sent to hiring manager processor 104 in many forms. For example, contractor teams 122 may be sent in a text list form. Contractor teams 122 may be sent to hiring processor 104 graphically with alternate possible selections. If hiring manager 102 selects one contractor in the contractor team 122 or changes details or weightings, contractor processor 110 may again process hiring details 108, profiles 112, profiles 140, social data 114 and ratings 142 to determine an updated list of contractor teams in response to the selected contractor.

Contractor teams 122 may include partially obfuscated information regarding contractors. For example, contractor teams 122 may include a description of a contractor's skills but not his/her name. The obfuscated information may be provided after hiring manager 102 indicates that (s)he intends to hire a particular contractor or pay for the hiring manager service.

In an example, profiles and social data may include or emphasize users internal to a company or group of companies. In this way, the described system may be used to generate teams of contractors who have relatively strong social connections to existing teams or an existing company.

In an example, a hiring manager may desired to hire two electrical engineers, a mathematician, a marketing specialist and three programmers. The hiring manager may enter technical details relating to all of these desired contractors. The hiring manager may further indicate that the marketing specialist should have a particular strength of a relationship with the mathematician and may provide corresponding weights for the technical details and social details. A contractor processor may receive profiles from a source and/or a social network. The contractor processor may further receive social data and ratings from available contractors. The contractor processor may process the technical details, social details, profiles, social data and ratings to determine contractor teams for the hiring manager.

Among other possible benefits, a system in accordance with the disclosure may allow a hiring manager to decide on a strength of a social connection between contractors in addition to technical details of the contractors. A search tool may be provided where social data may be used to mine and/or refine contractor hiring that can reflect the dynamics of a particular project or the culture of a hiring manager. Groups of contractors may be determined where those contractors have a connection to each other and/or to a hiring company. A company that owns a social network may be able to use the described system and enter a contractor hiring space. Groups of contractors may be determined where the contractors perform for the job and not necessarily for the individual contractor's benefit resulting in a contractor team with better communication and dedication. The system may co-optimize a search of technical details and social details. A search may determine contractors who have less than 100% match to input technical details but who have some match to the input social details. Multiple potential teams may be determined with different balances of skill diversity and strength of social connection.

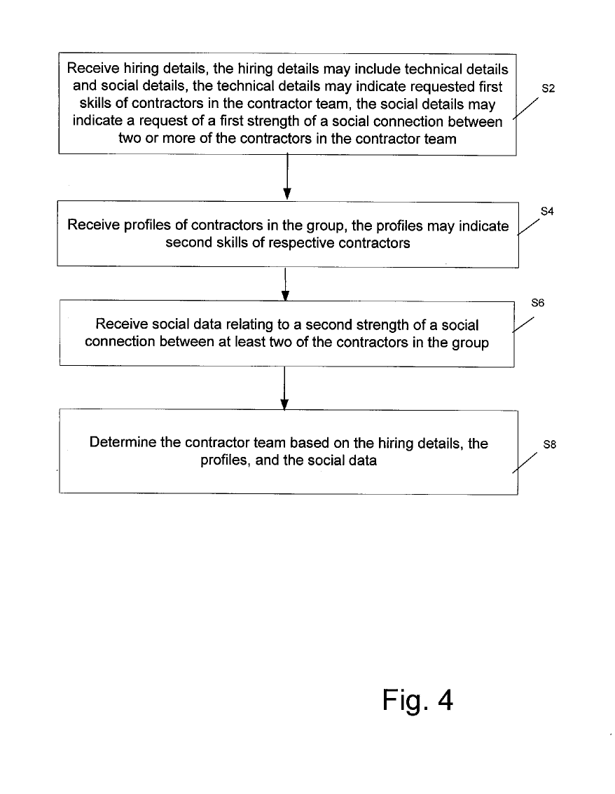

FIG. 4 depicts a flow diagram for example processes for implementing determination of a contractor team arranged in accordance with at least some embodiments described herein. The process in FIG. 4 could be implemented using, for example, system 100 discussed above to determine a contractor team from a group of contractors. An example process may include one or more operations, actions, or functions as illustrated by one or more of blocks S2, S4, S6, S8 and/or S10. Although illustrated as discrete blocks, various blocks may be divided into additional blocks, combined into fewer blocks, or eliminated, depending on the desired implementation.

Processing may begin at block S2, “Receive hiring details, the hiring details may include technical details and social details, the technical details may indicate requested first skills of contractors in the contractor team, the social details may indicate a request of a first strength of a social connection between two or more of the contractors in the contractor team.” At block S2, a processor may be configured to receive hiring details including technical details and social details. The technical details may indicate requested skills of contractors. The social details may indicate a request for a strength of a social connection between contractors. The technical details may include a technical weight indicating a level of importance of a requested match between the skills of the contractors and the technical details. The social details may include a social weight indicating a level of importance of a requested match between the requested and actual strength of a social connection between two or more contractors. The social details may indicate a requested strength of social connection among two or more contractors in the team.

Processing may continue from block S2 to block S4, “Receive profiles of contractors in the group, the profiles may indicate second skills of respective contractors.” At block S4, the processor may receive profiles of contractors. The profiles may be received from a contractor marketplace site or a social network.

Processing may continue from block S4 to block S6, “Receive social data relating to a second strength of a social connection between at least two of the contractors in the group.” At block S6, the processor may receive social data relating to a strength of a connection between at least two of the contractors in the group. For example, the processor may receive a social connection graph from a social network such as through use of an application programming interface or an OAUTH call.

Processing may continue from block S6 to block S8, “Determine the contractor team based on the hiring details, the profiles, and the social data.” At block S8, the processor may determine the contractor team based on the hiring details, profiles and the social data. The processor may receive ratings from the contractors indicating a level of interest of a second contractor to work with a first contractor. The processor may use the ratings to determine the contractor team.

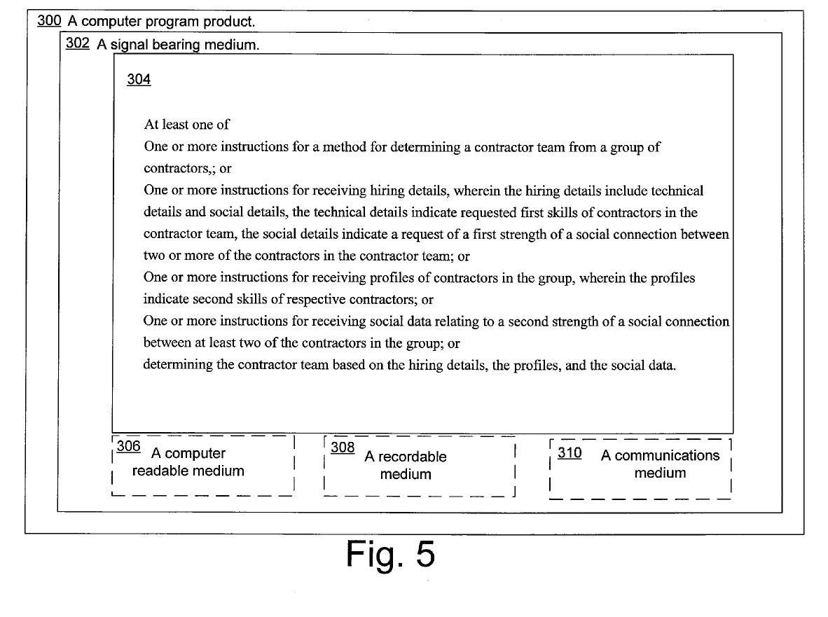

FIG. 5 illustrates computer program products 300 for implementing determination of a contractor team arranged in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-4. Thus, for example, referring to system 100, contractor processor 110 may undertake one or more of the blocks shown in FIG. 5 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

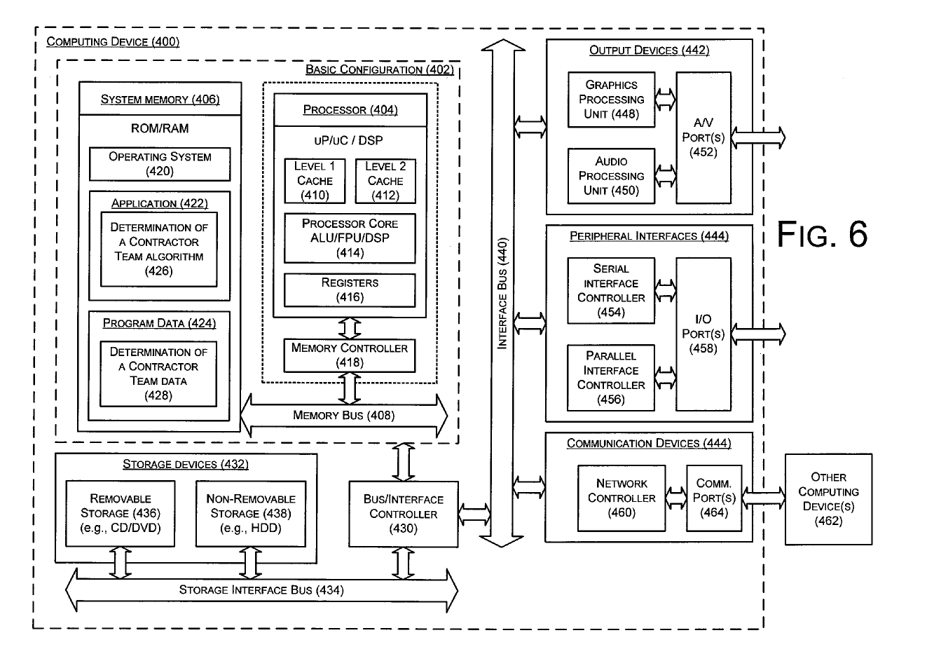

FIG. 6 is a block diagram illustrating an example computing device 400 that is arranged to implement determination of a contractor team arranged in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424.

Application 422 may include a determination of a contractor team algorithm 426 that is arranged to perform the functions as described herein including those described previously with respect to FIGS. 1-5. Program data 424 may include determination of a contractor team data 428 that may be useful for implementing determination of a contractor team as is described herein. In some embodiments, application 422 may be arranged to operate with program data 424 on operating system 420 such that determination of a contractor team may be provided. This described basic configuration 402 is illustrated in FIG. 6 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for determining a contractor team from a group of contractors, the method comprising, by a processor:
receiving hiring details, wherein the hiring details include technical details and social details, the technical details indicate requested first skills of contractors in the contractor team, the social details indicate a request of a first strength of a social connection between two or more of the contractors in the contractor team;
receiving profiles of contractors in the group, wherein the profiles indicate second skills of respective contractors;
receiving social data relating to a second strength of a social connection between at least two of the contractors in the group; and
determining the contractor team based on the hiring details, the profiles, and the social data.

2. The method of claim 1, wherein the hiring details include a technical weight for the technical details, and a social weight for the social details.

3. The method of claim 1, wherein:
the hiring details include a technical weight for the technical details, and a social weight for the social details; and
the technical weight indicates a level of importance of a requested match between the first skills and the second skills.

4. The method of claim 1, wherein:
the hiring details include a technical weight for the technical details, and a social weight for the social details; and
the social weight indicates a level of importance of a requested match between the first strength and the second strength.

5. The method of claim 1, further comprising:
receiving a rating of a first contractor from a second contractor, wherein the rating indicates a level of interest of the second contractor to work with the first contractor; and
determining the contractor team based on the rating.

6. The method of claim 1, further comprising determining two or more contractor teams based on the hiring details, the profiles and the social data.

7. The method of claim 1, wherein the first strength indicates a requested social connection among all contractors in the contract team.

8. The method of claim 1, wherein:
the first strength indicates a social connection between two contractors in the contractor team; and
the contractor team includes more than two contractors.

9. The method of claim 1, further comprising receiving one of the profiles from a contractor marketplace site.

10. The method of claim 1, further comprising receiving one of the profiles from a social network.

11. The method of claim 1, further comprising receiving a social connection graph from a social network, wherein the social connection graph includes the social data.

12. The method of claim 1, further comprising:
using an application programming interface to make a call to a social network for the social data; and
receiving a social connection graph from the social network in response to the call, wherein the social connection graph includes the social data.

13. The method of claim 1, further comprising:
using a third party authorization request to make a call to a social network for the social data; and
receiving a social connection graph from the social network in response to the call, wherein the social connection graph includes the social data.

14. The method of claim 1, wherein the social data and at least some of the profiles are received from a social network.

15. The method of claim 1, wherein the social details indicate that contractors in the contractor team are requested to be a certain number of hops from each other in a social graph.

16. The method of claim 1, wherein the social details indicate that contractors in the contractor team are requested to be connected by a threshold strength level in a social graph.

17. The method of claim 1, wherein the social details indicate that contractors in the contractor team are requested to be a certain number of hops from a company in a social graph or a threshold strength from the company in the social graph.

18. The method of claim 1, further comprising sending a representation of the contractor team to a hiring processor with at least some of the information relating to the contractor team obfuscated.

19. The method of claim 1, further comprising:
sending a representation of the contractor team to a hiring processor;
receiving a selection of at least one of the contractors on the contractor team; and
determining an updated contractor team based on the selection, the hiring details, the profiles and the social data.

20. A device configured to determine a contractor team from a group of contractors, the device comprising:
a memory including instructions; and
a processor configured to communicate with the memory, the processor configured to:
receive hiring details, wherein the hiring details include technical details and social details, the technical details indicate requested first skills of contractors in the contractor team, the social details indicate a request of a first strength of a social connection between two or more of the contractors in the contractor team;
receive profiles of contractors in the group, wherein the profiles indicate second skills of respective contractors;
receive social data relating to a second strength of a social connection between at least two of the contractors in the group; and
determine the contractor team based on the hiring details, the profiles, and the social data.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A system configured to determine a contractor team from a group of contractors, the system comprising:
a contractor marketplace site;
a social network; and
a contractor processor configured to be in communication with the contractor marketplace site and the social network;
the contractor processor configured to
receive hiring details, wherein the hiring details include technical details and social details, the technical details indicate requested first skills of contractors in the contractor team, the social details indicate a request of a first strength of a social connection between two or more of the contractors in the contractor team;
receive profiles of contractors in the group from the contractor marketplace site, wherein the profiles indicate second skills of respective contractors;
receive a social connection graph from the social network, wherein the social connection graph relates to a second strength of a social connection between at least two of the contractors in the group; and
determine the contractor team based on the hiring details, the profiles, and the social data.

40. (canceled)
